(19) United States
(12) Patent Application Publication
(10) Pub. No.: US 2012/0019342 A1
(43) Pub. Date: Jan. 26, 2012

(54) Magnets made from nanoflake precursors

(76) Inventors: Alexander Gabay, Newark, DE (US); Baozhi Cui, Tallahassee, FL (US); Melania Marinescu, Reinholds, PA (US); Jinfang Liu, Lancaster, PA (US); George C. Hadjipanayis, Centerville, DE (US)

(21) Appl. No.: 12/840,733

(22) Filed: Jul. 21, 2010

(51) Int. Cl. H01F 7/02; B02C 17/00; B22F 3/10; B02C 23/18; B22F 1/00; B22F 3/02

(52) U.S. Cl. 335/306; 419/33; 419/62; 241/16; 241/27

(57) ABSTRACT

RE-TM based permanent magnets (single phase, hybrid, laminated or polymer bonded magnets) fabricated by using nanoflakes produced by surfactant assisted, wet, high energy ball-milling, with or without prior dry high energy ball-milling, where RE represents rare earth elements and TM represents transition metals.

### STATEMENT OF GOVERNMENT SUPPORT

This invention was made with government support under Award No. IIP-0848996 awarded by the National Science Foundation. The United States government has certain rights in the invention.

### BACKGROUND OF THE INVENTION

The present invention is directed to bulk magnets comprising nanoflakes fabricated by surfactant-assisted, wet, high energy balling-milling various precursors. The nanoflakes may consist of different metallic phases belonging to the same group of magnetic materials, such as hard magnetic or soft magnetic, and a non-magnetic metallic or polymer binder phase.

High energy ball milling has been used for manufacturing nanocrystalline and amorphous materials, including rare earth-transition metal (RE-TM) permanent magnet materials, while independently, surfactants have been used to control the size, shape and properties of metal or ceramic powders during the low energy conventional milling, as described in the references:

Haneda & Kojima, J. American Ceram. Soc 57, 68 (1974)

J. S. Benjamin, Sci. Am. 234, 40 (1976)

Schultz et al. Journal of Applied Physics, 61, 8, 3583 (1987)

Wecker, at al. Applied Physics Letters, 69, 8, 6058 (1991)

Campbell, et. al. IEEE Transactions on Magnetics, 30, 2, 742 (1994)

M. Q. Zhao, Powder Metall. Technol. 14, 2, 88 (1996)

C. Suryanarayana, Pro. Mater. Sci. 46, 1 (2001)

Umbrajkar, et. al., Journal of Alloys & Compounds, 402, 70 (2005)

Zhou, et. al., J. Magn. Magn. Mater. 292, 325 (2005)

Chakka, et. al., Journal of Applied Physics 99, 09, 912 (2006)

Zhou, et. al. Journal of Magnetism and Magnetic Materials, 320, 3390 (2008)

Zhou, et. al., Journal of Alloys & Compounds 448, 303 (2008)

Khitouni, et. al., Journal of Alloys & Compounds, 475, 581 (2009)

Gabay, et al., J. Phys. Condens. Mater., in press (2010)

U.S. Pat. No. 6,344,271; and U.S. Patent Application 2006/0035087/A1. All of the foregoing references are incorporated herein by reference.

The Campbell, et al. references teaches—Wet-milling barium ferrite in the presence of cationic or anionic surface active substances, besides showing a faster reduction in particle and grain sizes compared with dry-milling also, on the basis of x-ray textural effects, indicates pronounced basal plane bias for the grains milled with surfactants in an external magnetic field. Room temperature and 4.2 K Mossbauer effect measurements on these milled samples reveal relaxation effects in the spectra due to superparamagnetic relaxation of the finest in the distributions of particle sizes produced, i.e., about 0.5 to 10 μm for dry milling; and about 0.1 to 1 μm for surfactant-assisted milling. The similarities in magnetic and structural properties resulting when barium ferrite is wet-milled with cationic or anionic surfactants below its zero point charge are linked with the equivalent interfacial behavior of the surfactants, governed by electrostatic interactions.

The Chakka, et al. reference teaches—The mechanism of ball-milling is fairly complex and does not lend itself easily to rigorous theoretical analysis due to its dynamic nature. The nanorods could be produced by fracture along some preferred crystalline orientation or anisotropic growth of the nanoparticles during the milling. Increase in the temperatures locally inside the milling vial may facilitate the growth. Materials with hexagonal—(for SmCo₅, Sm₂Co₁₇, Co) and tetragonal (for Nd₂Fe₁₄B) structures have a preferred orientation for fracture which are the close-packed planes [(0001) for hcp], and form plate-like structures, which upon further milling would result in the formation of elongated nanoparticles. This may also explain the absence of elongated structures in the case of Fe and FeCo which have bcc (body centered cubic) structure.

The Zhou, et al. reference teaches—Flake-like nanocrystalline Fe₃Co₂ alloy has been synthesized by two-step MA. Structure and morphology evolutions process during milling and further modulate the electromagnetic performance in microwave. As far as shape dependence of dynamic magnetization and electric polarization is concerned, flake-like Fe₃Co₂ particles with advanced morphology could maximize susceptibility, and predict high value of complex permeability and permittivity. On the other hand, crystal structure also determines the characteristic magnetic or electric parameters. For sphere-like powders, as milling processes, magnetic hardening emerges due to the structural evolution toward amorphous state, and reduces permeability. By virtue of the fixed crystal lattice and decreased grain size, magnetic softening caused by the enhancement of exchange coupling, is observed for flake-like particles, in line with the increase of complex permeability. Magnetoelastic effect does not find even when Co atoms dissociate from alloy. Surface anisotropy for nanograins is assumed to contribute to the multiresonances. However, further work is in progress to give a more profound insight in this issue.

The Khitouni, et al. reference states—Mechanical milling of elemental powders has been thoroughly investigated in various conditions of energy transfer to prepare non equilibrium materials, such as amorphous, nanocrystals, supersaturated solid solutions and other metastable phases and to identify the mechanism by which the materials deform to produce nanometer-sized grains. The deformation structures of materials under mechanical milling were rarely reported, and such are very important for one to get a better understanding of the mechanisms governing the mechanical milling process, since it is still not well understood. It has been shown that enhanced reaction rates can be achieved and dynamically maintained during milling as a result of microstructural refinement and mixing processes accompanying repeated fracture, deformation and welding of particles during collision events. When metallic powder is milled, the grain size of the powder particles continues to decrease until it reaches a minimum level in the range of 3 to 25 nm. For some cases, the powder becomes amorphous beyond this point. Furthermore, through a large amount of published research work on the amophization of pure elements such as Si, Ge, Se, it was found that the amorphization process has been related to crystalline phase instability, related to a lattice expansion due to a critical crystallite size refinement induced by ball milling.

The above referenced prior art neither discloses nor suggests that nanoflakes with the distinguishing properties claimed herein can be fabricated from RE-TM precursors via surfactant-assisted, wet, high energy ball-milling. Further, the prior art neither discloses nor suggests that bulk magnets can be fabricated from this type of nanoflakes. Accordingly, the following objectives of the invention are set forth.

### OBJECTS OF THE INVENTION

An object of the present invention is to fabricate permanent magnets from nanoflakes produced by surfactant-assisted, wet high energy ball-milling.

Another object of the present invention is to fabricate soft magnets from nanoflakes produced by surfactant-assisted, wet high energy ball-milling.

A further object of the invention is to fabricate by surfactant-assisted, wet, high energy ball-milling nanoflakes from various brittle materials, which nanoflakes are suitable for fabricating conventional single phase magnets, hybrid, laminated or polymer bonded magnets.

Still another object of the invention is to fabricate nanoflakes with various magnetic properties, including isotropic hard, isotropic soft, anisotropic hard and anisotropic soft; wherein the nanoflakes are useful in fabricating conventional single phase magnets, hybrid, laminated and/or polymer bonded magnets.

Yet another object of the invention is to fabricate anisotropic polycrystalline nanoflakes from RE-TM permanent magnet alloys, wherein the nanoflakes have utility in a broad range of permanent magnets and RE represents rare earth elements including Sm, Nd, Gd, Er, Tb, Pr, and Dy and mixtures thereof, TM is selected from the group consisting of transition metal elements including Fe, Co, and combinations thereof, and other metallic or non-metallic elements such as Cu, Zr, Al, Ga, Nb, Hf, B, and impurity traces such as O, C.

Another object of the invention is to fabricate SmCo₅ anisotropic nanoflakes by surfactant assisted wet high energy ball-milling; wherein the nanoflakes are useful in fabricating conventional single phase permanent magnets, hybrid, laminated and/or polymer bonded permanent magnets.

Still another object of the invention is to fabricate SmCo₅ isotropic nanoflakes with improved intrinsic coercivity using dry high energy ball milling followed by surfactant assisted, wet, high energy ball-milling; wherein the nanoflakes are subjected to recrystallization annealing to improve coercivity and wherein the nanoflakes are useful in fabricating conventional single phase permanent magnets, composite, nanocomposite, hybrid, laminated and/or polymer bonded permanent magnets.

Yet another object of the invention is to fabricate nanoflakes stacked in kebab-like structures, by surfactant-assisted, wet, high energy ball-milling, and to use these stacked nanoflakes in various hard and soft magnets.

### SUMMARY OF THE INVENTION

The present invention is directed to the fabrication of bulk magnets by using nanoflake precursors consisting of one or more metallic phases with similar magnetic properties, such as either hard magnetic or soft magnetic, with or without a non-magnetic binder phase. Particular emphasis is on RE-TM based bulk permanent magnets (with hard magnetic properties) where RE represents rare earth elements and TM represents transition metals. Although the precursor RE-TM alloy materials are inherently brittle and not suitable for fabrication into particles with high aspect ratio, surprisingly it has been found that one can control the precursor particle shape by using surfactant assisted, wet, high energy ball milling with or without prior dry high energy ball milling.

The RE-TM nanoflakes obtained via the surfactant-assisted, wet, high energy ball-milling or a combination of dry and surfactant-assisted, wet, high energy ball-milling have utility as magnetic components in the fabrication of permanent magnets (conventional single phase, hybrid or polymer bonded). The methods for the fabrication of these RE-TM permanent magnets include but are not limited to sintering, hot pressing, die upsetting, combustion driven compaction, compression molding, injection molding and/or calendaring.

Surfactants used in surfactant-assisted, wet, high energy ball milling stage of the invention, such as oleic acid, play a critical role in the formation of nanoflakes of the invention from inherently brittle materials.

Wet, high energy ball-milling in non-polar solvents (e.g., heptane) without surfactant results in the formation of magnetically isotropic equiaxed RE-TM microparticles. In contrast, closely packed kebab-like SmCo₅ nanoflakes are fabricated by high energy ball-milling in heptane with 15 wt. % oleic acid as surfactant. The increase of the surfactant level from 15 wt. % to 150 wt. % results in well separated, well-defined nanoflakes, rather than the kebab-like SmCo₅ nanoflakes observed with 15 wt. % surfactant. These “well separated” SmCo₅ nanoflakes are polycrystalline with the crystallite sizes ranging between 4 to 8 nm and indicate enhanced out-of-plane texture and magnetic anisotropy. The intrinsic coercivity of these SmCo₅ well separated nanoflakes was 18 kOe.

When the SmCo₅ alloys are firstly dry, high energy ball milled, the nanocrystalline structure in the course of dry milling the SmCo₅ alloys influences the evolution of the particle shape fabricated during the subsequent surfactant-assisted, wet, high energy ball milling stage as well as the ductility (malleability) of the resultant nanoflake of the invention. That is, the evolution of the particle shape for nominally brittle, RE-TM alloys, wet-milled after prolonged, surfactant-assisted dry-milling according to the invention is comparable to that of a wide range of ductile (malleable) materials. The nanoflakes of the invention formed by dry, high energy ball milling followed by wet, surfactant assisted, high energy ball milling, are magnetically isotropic.

In a preferred embodiment of the invention, the anisotropic nanoflakes are fabricated by surfactant-assisted, high energy ball milling of SmCo₅ ingots in heptane and a surfactant such as oleic acid. Isotropic SmCo₅ nanoflakes of the invention are produced by a succession of dry, high energy, ball milling followed by wet, surfactant assisted, high energy ball milling. Other materials of the invention that are transformed into nanoflakes when subjected to surfactant assisted, high energy ball milling with or without prior dry high energy ball milling are selected from the group consisting of Fe, Fe—Co, other transition metals, Nd—Fe—B, other rare earth based intermetallic compounds, and combinations thereof.

The anisotropic, with close-to-bulk magnetic properties, permanent magnet nanoflakes of the present invention bridge the gap toward the nanoparticle-based composite permanent magnets theoretically predicted to double the maximum energy product of the currently available magnets.

Embodiments of the invention include the following:

(a) Permanent magnets fabricated from magnetic nanoflakes produced by surfactant-assisted, wet, high energy ball-milling, wherein the nanoflakes are anisotropic.

(b) Permanent magnets fabricated from magnetic nanoflakes produced by surfactant-assisted, wet, high energy ball-milling, wherein the nanoflakes are isotropic.

(c) Permanent magnets fabricated from magnetic nanoflakes produced by surfactant-assisted, wet, high energy ball-milling preceded by dry high energy ball milling; wherein the nanoflakes are isotropic.

(d) Permanent magnets as in (a), (b), or (c) above, wherein the surfactant is selected from the group consisting of anionic, cationic, nonionic, amphoteric, zwitteronic surfactants and mixtures thereof.

(e) Permanent magnets as in (a), (b), or (c) above, wherein the surfactant is oleic acid.

(f) Permanent magnets as in (a), (b), or (c) above, wherein the nanoflakes are polycrystalline.

(g) Permanent magnets as in (a), (b), or (c) above, wherein the nanoflakes comprise RE-TM permanent magnet alloys, where RE represents one or more rare earth elements and TM represents one or more transition metals.

(h) Permanent magnets as in (a) above, wherein the nanoflakes arrange themselves into kebab-like stacks along nanoflakes shortest axes.

(i) Permanent magnets as in (h) above, where the nanoflakes are SmCo₅ nanoflakes.

(j) Permanent magnets as in (a) above, wherein the nanoflake precursors are well separated anisotropic SmCo₅ nanoflakes.

(k) Permanent magnets as in (b) or (c) above, wherein the nanoflake precursors are well separated isotropic nanoflakes.

(1). Soft magnets fabricated from Fe-based nanoflakes produced by surfactant-assisted, wet, high energy balling-milling.

(m) RECoₓ permanent magnets fabricated from nanoflakes produced by surfactant-assisted, wet, high energy ball-milling, wherein x is 3 to 6 and RE represents rare earth elements including Sm, Gd, Er, Tb, Pr, and Dy and mixtures thereof.

(n) The RECoₓ permanent magnets as in (m) above, further comprising no more than about 10 atomic % of other metallic or non-metallic elements.

(o) RE(CoᵤFeᵥCu_{w}Zrₕ)_{z}, permanent magnets fabricated from nanoflakes produced by surfactant-assisted, wet, high energy ball-milling, wherein u is 0.5 to 1, v is 0 to 0.45, w is 0 to 0.3, h is 0 to 0.07, and z is 6 to 9; and wherein RE is selected from the group consisting of Sm, Gd, Er, Tb, Pr, Dy and combinations thereof.

(p) RE_{11.7+x}TM_{88.3-x-y}B_{y} permanent magnets fabricated from nanoflakes produced by surfactant-assisted, wet, high energy ball-milling, wherein x is 0 to 5, y is 5 to 7 and RE is selected from the group consisting of rare earth elements including Nd, Pr, Dy, Tb, and combinations thereof, and TM is selected from the group consisting of transition metal elements including Fe, Co, Cu, Ga, Al and combinations thereof.

(q) Permanent magnets as in (m), (n), (o), or (p) above, wherein the nanoflakes form a laminated structure.

(r) Permanent magnets as in (m), (n), (o), or (p) above, wherein the nanoflakes are bonded with a binder.

(s) The permanent magnets as in (r) above, wherein the binder is selected from the group consisting of metallic binders or non-metallic binders.

(t) The permanent magnets as in (r) above, wherein the binder comprises an epoxy binder.

(u) A method of manufacturing permanent magnets comprising the steps of:
(1) forming nanoflakes by surfactant assisted wet, high energy ball-milling; and
(2) fabricating permanent magnets from the nanoflakes.

(v) The method as in (u) above, wherein the step of forming the nanoflakes further comprises the use of dry high energy ball-milling prior to the surfactant assisted wet, high energy ball-milling.

(w) The method as in (u) above, wherein the step of fabricating the permanent magnets is selected from the group consisting of sintering, plasma sintering, infrared sintering, microwave sintering, hot pressing, die upsetting, combustion driven compaction, compression molding, injection molding, calendaring, and combinations thereof.
(x) Permanent magnets comprising isotropic or anisotropic, polycrystalline, nanoflake permanent magnet powders fabricated by surfactant-assisted, wet, high energy ball-milling of precursor materials selected from the group consisting of:
(1) SmCo₅ nanoflakes as illustrated in FIG. 2;
(2) SmCo₅ nanoflakes as illustrated in FIG. 3;
(3) SmCo₅ microparticles and nanoflakes as illustrated in FIG. 4:
(4) SmCo₅ microparticles and nanoflakes as illustrated in FIG. 5;
(5) SmCo₅ nanoflakes as illustrated in FIG. 6;
(6) SmCo₅ microparticles and nanoflakes as illustrated in FIG. 7;
(7) SmCo₅ nanoflakes as illustrated in FIG. 8;
(8) SmCo₅ nanoflakes as illustrated in FIG. 9;
(9) SmCo₅ nanoflakes as illustrated in FIG. 10;
(10) SmCo₅ nanoflakes as illustrated in FIG. 11;
(11) SmCo₇ nanoflakes as illustrated in FIG. 12;
(12) SmCo₇ nanoflakes as illustrated in FIG. 13;
(13) Sm₂(Co_{0.8}Fe_{0.2})₁₇ nanoflakes as illustrated in FIG. 14;
(14) Sm(Co,Fe,Cu,Zr)_{z} (where z=7 to 7.4) nanoflakes as illustrated in FIG. 15;
(15) Sm(Co,Fe,Cu,Zr)_{z} (where z=7 to 7.4) nanoflakes as illustrated in FIG. 16;
(16) α-Fe nanoflakes as illustrated in FIG. 17;
(17) single-crystal micron, submicron nanoflakes and textured polycrystalline nanoflakes of SmCo₅ as illustrated in FIGS. 18; and
(18) SmCo₅ nanoflakes as illustrated in FIG. 19.

### BRIEF DESCRIPTION OF THE DRAWINGS

FIG. 1 illustrates scanning electron microscope images of dry-milled SmCo₅ alloy milled for (a) 1 minute (min.), (b) 15 min. and (c) 240 min.; examples of (d) loosely and (e) densely, cold-welded particles after milling for 45 and 240 min., respectively.

FIG. 2 illustrate scanning electron microscope images of SmCo₅ nanoflakes of the invention after surfactant-assisted, wet milling for 180 min. preceded by dry milling for (a) 0 min., (b) 15 min. and (c) 240 min.

FIG. 3 illustrates transmission electron microscope images of SmCo₅ nanoflakes of the invention after surfactant-assisted, wet milling for 180 min. which was preceded by dry milling for 240 min. (a) as-milled and (b) annealed for 30 min. at 650° C.

FIG. 4 shows x-ray diffraction patterns of (a) non-aligned (b) and magnetically aligned SmCo₅ microparticles and nanoflakes prepared by high energy ball milling for 5 hours (h) in heptane with 0, 15, 40, 150 wt. % oleic acid as surfactant, respectively and 50:1 ball to powder ratio.

FIG. 5 illustrates scanning electron microscope images of SmCo₅ microparticles and nanoflakes prepared by high energy ball milling for 5 hours (h) in heptane with (a) 0, (b) 15, (c) 40, (d) 150 wt. % oleic acid as surfactant, respectively and 50:1 ball to powder ratio. The right column shows enlarged selected areas from the images shown in the left column.

FIG. 6 illustrates in-plane transmission electron microscope images of SmCo₅ nanoflakes of the invention prepared by high energy ball milling for 5 h in heptane with 15 wt. % oleic acid as surfactant and 50:1 ball to powder ratio.

FIG. 7 shows hysteresis curves of SmCo₅ microparticles and nanoflakes of the invention prepared by high energy ball milling for 5 h in heptane with 0, 15, 40, and 150 wt. % oleic acid as surfactant, respectively, and 50:1 ball to powder ratio, and then aligned with 19 kOe in parallel directions. These curves were measured after magnetizing in 20 kOe.

FIG. 8 shows scanning electron microscope micrographs for SmCo₅ nanoflakes of the invention produced by wet, high energy, ball milling for 4 h, with 15 wt. % oleic acid as surfactant and 10:1 ball to powder ratio.

FIG. 9 shows x-ray diffraction pattern for SmCo₅ nanoflakes of the invention produced by high energy ball milling for 4 h with 15 wt. % oleic acid as surfactant and 10:1 ball to powder ratio (a) theoretical data for randomly oriented crystallites, (b) experimental data for flakes aligned by their easy magnetization directions in an external magnetic field. The inset shows the physical appearance of nanoflakes of the invention aligned in an externally applied magnetic field which corresponds to the pattern (b).

FIG. 10 shows demagnetization curves for SmCo₅ nanoflakes of the invention produced by high energy ball milling for 4 h with 15 wt. % oleic acid as surfactant and 10:1 ball to powder ratio. The curves are measured on random and aligned powders along different directions in respect to the alignment direction in order to demonstrate the anisotropic character of the flakes.

FIG. 11 shows demagnetization curves for SmCo₅ nanoflakes of the invention produced by high energy ball milling with 15 wt. % oleic acid as surfactant, and 10:1 ball to powder ratio, for different periods of time, ranging from 15 min. to 8 h.

FIG. 12 shows scanning electron microscope micrographs for SmCo₇ nanoflakes of the invention produced by high energy ball milling for 4 h with 15 wt. % oleic acid as surfactant and 10:1 ball to powder ratio.

FIG. 13 shows demagnetization curves for SmCo₇ nanoflakes of the invention produced by high energy ball milling for 4 h with 15 wt. % oleic acid as surfactant and 10:1 ball to powder ratio. The curves are measured on random and aligned nanoflakes along different directions in respect to the alignment direction in order to demonstrate the anisotropic character of the nanoflakes.

FIG. 14 shows x-ray diffraction pattern for Sm₂(Co_{0.8}Fe_{0.2})₁₇ nanoflakes of the invention produced by high energy ball milling for 4 h with 15 wt. % oleic acid as surfactant and 10:1 ball to powder ratio (a) theoretical data for randomly oriented crystallites (b) experimental data for nanoflakes of the invention aligned by their easy magnetization directions in an external magnetic field.

FIG. 15 shows scanning electron microscope micrographs for Sm(Co,Fe,Cu,Zr)_{z} (z=7 to 7.4) nanoflakes of the invention processed by high energy ball milling for 4 h with 150 wt. % oleic acid as surfactant and 10:1 ball to powder ratio (a) individual nanoflakes of the invention with no magnetic field applied and (b) nanoflakes of the invention in an applied magnetic field.

FIG. 16 shows demagnetization curves for Sm(Co,Fe,Cu,Zr)_{z} (z=7 to 7.4) nanoflakes of the invention produced by high energy ball milling with 150 wt. % oleic acid as surfactant and 10:1 ball to powder ratio, for different periods of time, ranging from 30 min. to 4 h.

FIG. 17 shows electron microscope micrographs of α-Fe nanoflakes of the invention, high energy ball-milled for 16 h in heptane and 15 wt. % oleic acid as surfactant and 10:1 ball to powder ratio.

FIG. 18 illustrates schematically the evolution and formation mechanism of single-crystal micron, submicron nanoflakes and then textured polycrystalline nanoflakes from SmCo₅ ingot, (a) bulk ingot with polycrystalline of sizes of about 40 to 100 μm; (b) single-crystal particles of sizes of 1 to 40 μm; (c) single-crystal micron nanoflakes; (d) single-crystal submicron nanoflakes with small-angle subgrain boundaries; (e) textured polycrystalline nanoflakes.

FIG. 19 shows scanning electron microscope micrographs of SmCo₅ microparticles (crushed ingot powders), micron nanoflakes prepared by high energy ball milling in heptane with 15 wt. % oleic acid for (a) 0, (b) 0.25, (c) 0.5 h, respectively. The cleft and stepped (001) basal planes of SmCo₅ can be commonly seen in the single-crystal micron nanoflakes of the invention prepared by high energy ball milling from 0.25 to 0.5 h.

FIG. 20 shows scanning electron microscope micrographs of permanent magnets produced by hot pressing SmCo₅ precursor nanoflakes synthesized by wet, surfactant assisted high energy ball milling prior subjected to dry high energy ball milling.

FIG. 21 represents the demagnetization curve of magnetically isotropic permanent magnets produced by hot pressing isotropic SmCo₅ precursor nanoflakes synthesized by wet, surfactant assisted high energy ball milling prior subjected to dry high energy ball milling.

### DETAILED DESCRIPTION OF PREFERRED EMBODIMENTS

For purposes of clarity, the following definitions are provided to aid understanding of specific embodiments of the invention.

“Nanoparticles”, as the term is used herein, are particles with at least one size of less than 100 nanometers.

“Aspect ratio”, as the term is used herein, refers to the ratio of the maximum to the minimum dimension of the particle.

“Submicron powders”, as used herein, refers to powders with a mean particle size less than 1 micron and an aspect ratio between 1 and 1,000,000.

“Nanostructured”, as used herein, define polycrystalline substances with a mean crystallite size less than 100 nm and with extremely high interfacial areas. Nanostructured materials can be prepared by methods such as those taught in U.S. Pat. Nos. 5,486,675; 5,788,738; 5,447,708; 5,407,458; 5,219,804; 5,194,128; 5,064,464; all of which are incorporated herein by reference.

“Microparticles”, as used herein, define equiaxed particles with sizes in the range of 0.1 micron to 100 microns.

“Powders”, as the term is used herein, are powders that include particles with mean size less than about 100 microns and preferably less than about 10 microns with an aspect ratio between 1 and 1,000,000.

“Hard magnets”, also called permanent magnets, are ferromagnetic or ferrimagnetic materials intrinsic coercivity greater than 500 Oe.

“Soft magnets” are ferromagnetic or ferrimagnetic materials with intrinsic coercivity less than 100 Oe that can easily be magnetized in externally applied magnetic field.

“Anisotropic magnet powders of the invention” refers to magnet powders which can attain crystallographic texture through rotation of individual particles, such as when subjected to a magnetic field. Once the crystallographic texture is attained, the anisotropic magnet powders have different magnetic properties along different directions.

“High energy ball milling” or “HEBM” refers to a ball milling characterized by very high impact velocities and very high impact frequencies of the grinding media compared to regular milling (e.g., with a rotary mill). High energy ball milling can be done with a SPEX shaker mill.

“RE-TM permanent magnet alloys” refers to alloys comprising rare earth, transition metal, intermetallic compounds including RECo₅, RE₂TM₁₇ and RE₂TM₁₄B (where RE represents the rare earth elements and TM represents transition metal elements). These alloys can be in form of ingots, ribbons, powders or finished permanent magnets.

“Kebab-like” structures are parallel or quasi-parallel arrangement of particles with high aspect ratio (nanoflakes) forming stacks along the shortest dimension of the particles.

“Magnetic nanoflakes of the invention” refers to nanoflakes which have a high aspect ratio, with one dimension at least 10 times smaller than the other two dimensions. The thickness of the nanoflakes is less than 1 μm and preferably less than about 100 nm.

The polycrystalline anisotropic nanoflakes of the invention can be fabricated from brittle magnet materials including SmCo₅, PrCo₅, Sm₂ (Co_{0.8}Fe_{0.2})₁₇, as well as from soft Fe-based magnet materials, Sm—Co—Fe composite materials and other materials based on rare earth-transition metal or rare earth-transition metal—metalloid compounds.

“Single phase permanent magnets” refers to permanent magnets having one major metallic phase such as SmCo₅, Nd₂Fe₁₄B or other intermetallic compound. Other minority phases may be present and may or may not have effect on mechanical, electrical and magnetic properties.

“Composite magnets” refers to permanent magnets comprising multiple metallic and non-metallic phases which belong to different groups of materials with dissimilar properties.

“Nanocomposite magnets” refers to composite magnets, with at least one of the phases in the magnet having a mean particle size smaller than 1000 nm and preferably smaller than 100 nm.

“Bonded magnets” are magnets comprising one or more metallic magnetic filler phase and a non-magnetic metallic or polymer binder phase.

“Hybrid magnets” refers to magnets comprising two metallic phases, both belonging to the same group of magnetic materials, such as hard magnetic or soft magnetic.

“Laminated magnets” refers to magnets with a layered structure (morphology).

Various magnetic nanoflake-based powders of the invention are ideal articles of commerce suitable for use in fabricating single phase, composite, nanocomposite, bonded, hybrid or laminated permanent magnets and soft (Fe-based) magnets.

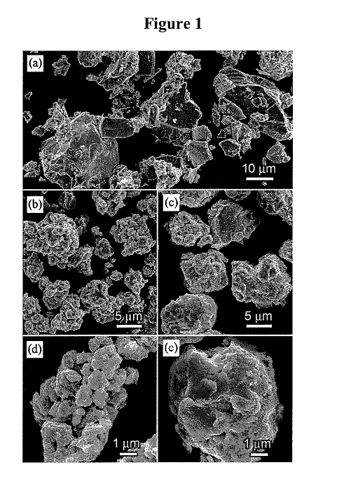

Nanoflake “powders” useful in the composite magnets of the invention have a broad compositional range as described and illustrated in detail in Examples 1 through 10 and corresponding FIGS. 1 through 17 of the Drawings.

Magnetic nanoflake powders suitable for use in the permanent magnets of the invention are selected from the group consisting of:

(a) isotropic SmCo₅ nanoflakes,

(b) other isotropic rare earth-based nanoflakes

(c) anisotropic SmCo₅ nanoflakes,

(d) other anisotropic rare earth-based nanoflakes, and

(e) Fe-based nanoflakes.

“Surfactants”, as used herein, is a contraction of the term “surface-active agent.” Surfactants are wetting agents that lower the surface tension of a liquid, allowing easier spreading. They are usually organic compounds soluble in water and/or organic solvents. The surfactant molecules are amphiphilic, meaning that they contain hydrophilic groups (“head” parts) and hydrophobic groups (“tail” parts). A broad range of surfactants are found to help control the morphology, size, distribution, state, shape, surface and bulk composition of the nanoflakes of the invention.

Surfactants suitable for use in the surfactant-assisted, wet, high energy ball milling step of the invention include a wide variety of synthetic, anionic, amphoteric, zwitteronic, cationic and nonionic surfactants, as detailed below.

Synthetic anionic surfactants can be exemplified by the alkali metal salts of organic sulfuric reaction products having their molecular structure an alkyl radical containing from 8 to 22 carbon atoms and a sulfonic acid or sulfuric acid ester radical (included in the term alkyl is the alkyl portion of higher acyl radicals). Preferred are the sodium, ammonium, potassium or triethanolamine alkyl sulfates, especially those obtained by sulfating the higher alcohols (8 to 18 carbon atoms), sodium coconut oil fatty acid monoglyceride sulfates and sulfonates; sodium or potassium sales of sulfuric acid esters of the reaction product of 1 mole of a higher fatty alcohol (e.g., tallow or coconut oil alcohols) and 1 to 12 moles of ethylene oxide ether sulfate with 1 to 10 units of ethylene oxide per molecule and in which the alkyl radicals contain from 8 to 12 carbon atoms, sodium alkyl glyceryl ether sulfonates; the reaction product of fatty acids having from 10 to 22 carbon atoms esterified with isethionic acid and neutralized with sodium hydroxide; water soluble salts of condensation products of fatty acids with sarcosine; and other known in the art.

Zwitteronic surfactants can be exemplified by those which can be broadly described as derivatives of aliphatic quaternary ammonium, phosphonium, and sulfonium compounds, in which the aliphatic radicals can be straight chain or branched, and wherein one of the aliphatic substituents contains from about 8 to 18 carbon atoms and one contains an anionic water-solubilized group, e.g., carboxyl, sulfonates, sulfate, phosphate, or phosphonate. A general formula for these compounds is:

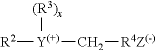

wherein R² contains an alkyl, alkenyl, or hydroxyl alkyl radical of from about 8 to 18 carbon atoms, from 0 to about 10 ethylene oxide moieties and from 0 to 1 glyceryl moiety; Y is selected from the group consisting of nitrogen, phosphorous, and sulfur atoms; R³ is an alkyl or monohydroxyalkyl group containing 1 to about 3 carbon atoms; X is 1 when Y is a sulfur atom and 2 when Y is a nitrogen or phosphorous atom; R⁴ is an alkylene or hydroxyalkylene of from 1 to about 4 carbon atoms and Z is a radical selected from the group consisting of carboxylate, sulfonate, sulfate, phosphonate, and phosphate groups. Examples include:
4-[N,N-di-(2-hydroxyethyl)-N-octadecylammonio]-butane-1-carboxylate;
5-(S-3-hydroxypropyl-S-hexadecylsulfonio]-3-hydroxypentane-1-sulfate;
3-[P,P-diethyl-P-3,6,9-trioxatetetradexocylphosphonio]-2-hydroxypropane-1-phosphate;
3-[N,N-dipropyl-N-3-dodecoxy-2-hydroxypropylammonio]-propane-1-phosphate;
3-[N,N-dimethyl-N-hexadecylammonio-propane-1-sulfonate;
4-[N,N-di(2-hydroxyethyl)-N-(2-hydroxydodecyl)ammonio-butane-1-carboxylate;
3-[S-ethyl-S-(3-dodecoxy-2-hydroxypropyl)sulfonio]-propane-1-phosphate;
3-[P,P-dimethyl-P-dodecylphosphonio]-propane-1-phosphonate; and
5-[N,N-di(3-hydroxypropyl)-N-hexadecylammonio]-2-hydroxypentane-1-sulfate.

Other zwitteronics such as betaines are also useful in the present invention. Examples of betaines useful herein include the higher alkyl betaines such as cocodimethyl carboxymethyl betaine, lauryl dimethyl carboxymethyl betaine, lauryl dimethyl alphacarboxyethylene betaine, cetyl dimethyl carboxymethyl betaine, lauryl bis-(2-hydroxy-ethyl)carboxy methyl betaine, stearyl bis-(20-hydroxypropyl)-carboxymethyl betaine, oleyl dimethyl gammacarboxypropyl betaine, lauryl bis-(2-hydroxypropyl)alpha-carboxyethyl betaine, etc. The sulfobetaines may be represented by cocodimethyl sulfopropyl betaine, stearyl dimethyl sulfopropyl betaine, lauryl dimethyl sulfoethyl betaine, lauryl bis-(2-hydroxy-ethyl)sulfopropyl betaine and the like; amido betaines and amidosulfo betaines, wherein the RCONH(CH₂)₃ radical is attached to the nitrogen atom of the betaine are also useful in this invention. The amido betaines are preferred for use in some of the compositions of this invention. A particularly preferred composition utilizes an amido betaine, a quaternary compound, a silicone, a suspending agent and has a pH of from about 2 to about 4.

Examples of amphoteric surfactants which can be used in the present invention are those which can be broadly described as derivatives of aliphatic secondary and tertiary amine in which the aliphatic radical can be straight chain or branched and wherein one of the aliphatic substituents contains from about 8 to about 18 carbon atoms and one contains an anionic water solubilizing group, e.g., carboxy, sulfonates, sulfate, phosphate, or phosphonate. Examples of compounds falling within this definition are sodium 3-dodecylamino-propionate, sodium 3-dodecylamino-propane sulfonate, N-aklyltaurines such as the one prepared by reacting dodecylamine with sodium isethionate according to the teaching of U.S. Pat. No. 2,658,072, N-higher alkyl aspartic acids such as those produced according to the teaching of U.S. Pat. No. 2,438,091, and the products sold under the trade name “Miranol” and described in U.S. Pat. No. 2,528,378.

Nonionic surfactants, which are preferably used in combination with an anionic, amphoteric or zwitteronic surfactant, can be broadly defined as compounds produced by the condensation of alkylene oxide groups (hydrophilic in nature) with an organic hydrophobic compound, which may be aliphatic or alkyl aromatic in nature. Examples of preferred classes of nonionic surfactants are described below.

The polyethylene oxide condensates of alkyl phenols, e.g., the condensation products of alkyl phenols having an alkyl group containing from about 6 to 12 carbon atoms in either a straight chain or branched chain configuration, with ethylene oxide, the ethylene oxide being present in amounts equal to 10 to 60 moles of ethylene oxide per mole of alkyl phenol. The alkyl substituent in such compounds may be derived from polymerized propylene, disobutylene, octane or nonane, for example.

Those derived from the condensation of ethylene oxide with the product resulting from the reaction of propylene oxide and ethylenediamine products which may be varied in composition depending upon the balance between the hydrophobic and hydrophilic elements which is desired. For example, compounds containing from about 40% to about 80% polyoxyethylene by weight and having a molecular weight of from about 5,000 to about 15,000 resulting from the reaction of ethylene oxide groups with a hydrophobic base constituted of the reaction produce of ethylene diamine and excess propylene oxide, the base having a molecular weight of the order of 2,500 to 3,000 are satisfactory.

The condensation product of aliphatic alcohols having from 8 to 18 carbon atoms, in either straight chain or branched chain configuration, with ethylene oxide, e.g., a coconut alcohol ethylene oxide condensate having from 10 to 30 moles of ethylene oxide per mole of coconut alcohol, the coconut alcohol fraction having from 10 to 14 carbon atoms.

Long chain tertiary amine oxides corresponding to the following general formula:

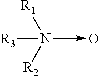

wherein R₁ contains an alkyl, alkenyl or monohydroxy alkyl radical of from about 8 to about 18 carbon atoms from 0 to about 10 ethylene oxide moieties, and from 0 to 1 glyceryl moiety, and R₂ and R₃ contains from 1 to about 3 carbon atoms and from 0 to about 1 hydroxy group, e.g., methyl, ethyl, propyl, hydroxyl ethyl, or hydroxypropyl radicals. The arrow in the formula is a convention representation of a semipolar bond. Examples of amine oxides suitable for use in this invention include dimethyl-dodecylamine oxide, oleyl-di-(2-hydroxyethyl)amine oxide, dimethyloctylamine oxide, dimethyldecylamine oxide, dimethyltetradecylamine oxide. 3,6,9-trioxahepota-decyldiethylamine oxide, di) 2-hydroxyethyl)tetracylamine oxide, 2-dodecoxy-ethyldimethylamine oxide, 3-dodecoxy-2-hydroxypropyldi-(3-hydroxy-propyl)amine oxide, dimethylhexadecylamine oxide.

Long chain tertiary phosphine oxides corresponding to the following general formula:

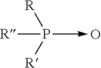

wherein R contain an alkyl, alkenyl or monohydroxyalkyl radical ranging from 8 to 18 carbon atoms in chain length from 0 to about 10 ethylene oxide moieties and from 0 to 1 glyceryl moiety and R′ and R″ are each alkyl or monohydroxyalkyl groups containing from 1 to 3 carbon atoms. The arrow in the formula is a conventional representation of a semipolar bond. Examples of suitable phosphine oxides are dodecyldimethylphosphine oxide, tetradecyldimethylphosphine oxide, tetradecylmethylethylphosphine oxide, 3,6,9-trioxaoctadecyldimethylphosphine oxide, cetyldimethylphosphine oxide, 3-dodecoxy-2-hydroxypropyl-di(2-hydroxyl)phosphine oxide, stearyldimethylphosphine oxide, cetylethylpropylphosphine oxide, cetyldiethylphosphine oxide, dodecyldiethylphosphine oxide, tetradecyldiethylphosphine oxide, dodecyldipropylphosphine oxide, dodecyldi(2-hydroxyethyl)phosphine oxide, tetradecylmethyl-2-hydroxydodecyldimethylphosphine oxide.

Long chain dialkyl sulfoxides containing one short chain alkyl or hydroxyl alkyl radical of 1 to about 3 carbon atoms (usually methyl) and one long hydrophosphic chain which contain alkyl, alkenyl, hydroxy alkyl, or keto alkyl radicals containing from about 8 to about 20 carbon atoms, from 0 to about 10 ethylene oxide moieties and from 0 to 1 glyceryl moiety. Examples include octadecyl methyl sulfoxide, 2-detotridecylmethyl-sulfoxide, 3,6,9,-trioxooctadecyl 2-hydroxyethyl sulfoxide, dodecyl methyl sulfoxide, oleyl 3-hydroxypropyl sulfoxide, tetradecyl methyl sulfoxide, 3-methoxytridecyl methyl sulfoxide, 3-hydroxytridecl methyl sulfoxide, 3-hydroxy-4-dodecoxybutyl methyl sulfoxide.

### EXAMPLES

The present invention is further described and illustrated by Examples 1 through 11 set forth below and detailed in FIGS. 1 through 21 of the Drawings.

### Introduction to Examples 1 and 2

Examples 1 and 2 are further illustrated in FIGS. 1 through 3 of the drawings. In examples 1 and 2, brittle SmCo₅ alloys were subjected to successive dry and wet high energy ball milling in the presence of a surfactant. Surprisingly, the evolution of nanoflakes-shaped particles from these nominally brittle alloys which were wet-milled after prolonged dry milling indicated malleability similar to that of ductile materials. This malleability/ductility induced by nanostructure is particularly unexpected. For example, SmCo₅ crushed ingots subjected to high energy ball-milling in heptane without surfactant transformed into rather equiaxed particles.

Alloys with the nominal composition Sm₁₇Co₈₃ (in at. %) which corresponds to SmCo₅ formula, were prepared from pure components by arc-melting. In order to offset oxidation of the RE during milling, the SmCo₅ alloys were made with 2 extra at. % (relative) of Sm to compensate for the evaporation loss of this element during melting. Prior to milling, which was performed at a ball-to-powder ratio of 8 to 10 using a Spex-8000M mill, the ingots had been crushed down to less than 300 μm. Dry high energy ball-milling was performed under argon (after evacuating the milling vial to 10⁻³ Torr) for up to 240 min. An additional milling in ethanol for 5 min. was used to collect the powder stuck to the milling ball and to the vial interior during the dry milling. Wet high energy ball-milling was performed in heptane for up to 720 min. The surfactant (oleic acid) was added to heptane in the amount of 0 to 150 wt. % of the powder mass. The products of the dry followed by wet surfactant assisted high energy ball milling were nanoparticles and nanoflakes. The nanoflakes usually precipitate relatively quickly at the bottom of the vial, when at rest. When the evolution of particle shape, from equiaxed to nanoflakes was studied, the powders (nanoflakes) were washed successively in heptane and ethanol three times. Some of the powders were additionally annealed for 30 min. at 500° C. to 600° C. under argon.

The structure and morphology of the various high energy ball-milled examples described herein were characterized by transition electron microscopy (TEM) with a JEOL JEM-3010 instrument, scanning electron microscopy (SEM) with a JEOL JSM-6335F instrument, and x-ray diffraction (XRD) with a Philips diffractometer operating with a Cu—Kα radiation. All TEM studies were carried out on as-obtained particles, without thinning The XRD data were processed with a Powder Cell program; crystallite size and microstrain were estimated from the broadening of the XRD peaks using the Williamson-Hall plots after correcting the XRD data for Kα₂ contribution and instrumental broadening. For magnetic measurements, which were performed at room temperature with a vibrating sample magnetometer, the samples were immobilized with wax in the presence of a 19 KOe orienting field and, in the case of SmCo₅, additionally magnetized by a pulsed field of 100 kOe.

### Example 1

The first example describes the evolution of SmCo₅ particles through dry, in Ar, high energy ball milling, which is the first step, prior to wet, surfactant assisted high energy ball-milling, in the fabrication of SmCo₅ nanoflakes of the invention. During the dry high energy ball milling, the SmCo₅ powders reveal a very rapid decline of the average particle size in the first minutes of the milling, as the cast material breaks up. Powders dry-milled for 1 min. are shown in FIG. 1(a); they consist mostly of non-agglomerated particles 1 to 30 μm in size with characteristically polygonal shapes and sharp edges. After 5 min. of milling, only few separate particles with these features can still be found, as the smallest particles are being increasingly coalesced with each other and with the bigger particles. As shown in FIG. 1(b) & (d), the newly assembled particles (agglomerates) appear “loose” and their size varies broadly from few microns to tens of microns. After prolonged milling, the assembled particles become denser and more uniform in size. The powders milled for 240 min. (the longest milling time used) as shown in FIG. 1(c) & (e) consist of particles ranging from 6 to 10 μm.

The structural properties of the dry-milled SmCo₅ alloy determined from broadening of the x-ray diffraction peaks and the corresponding hard magnetic properties are listed in Table 1. The average crystallite size rapidly reaches the nanometer range and, after 15 min., tends to saturate. After 240 min., the average crystallite size is found to be 6 nm. The microstrain also changes most rapidly during the first 15 min. of milling, but its tendency toward saturation is less pronounced than that of crystallite sizes disclosed in the literature (where x-ray diffraction peak broadening was analyzed with a different technique, the microstrain exhibited a nearly linear increase with milling time). The remanent magnetization reaches its maximum value after 1 min. of dry-milling, when break-up of the ingot already occurred, but without significant agglomeration of the particles or misorientation of the newly formed nanograins. After milling for 15 min., when the coercivity reaches its maximum value (presumably at the optimum combination of the average grain size and microstrain), the remanence of the field-oriented powder declines to the value which is expected for a polycrystalline material with randomly oriented uniaxially anisotropic non-interacting grains. With more prolonged dry-milling, the remanence increases again, whereas the coercivity decreases, which is expected in a nanocrystalline ferromagnet as the direct result of intergranular exchange coupling. Though local amorphization in the intergranular regions is likely, there are no sufficient reasons to consider an amorphous phase as the major factor leading to the decline of coercivity.

TABLE 1
Average crystalline size, microstrain, remanent magnetization
Mᵣ and intrinsic coercivity H_{ci} of Sm₁₇Co₈₃ (in at. %)
alloy after dry milling in argon are set out below.
Magnetization data are not corrected for self-demagnetizing field.

| | Crystallite | | | |
|---|---|---|---|---|
| Milling time | size | Microstrain | Mᵣ | H_{ci} |
| (min.) | (nm) | (%) | (emu/g) | (kOe) |
| 0 | >5000 | 0.01 | 20.1 | 1.5 |
| 1 | 75.4 | 0.10 | 81.4 | 11.5 |
| 15 | 23.1 | 0.39 | 53.6 | 18.7 |
| 45 | 12.2 | 0.50 | 54.3 | 16.8 |
| 240 | 6.0 | 0.68 | 61.3 | 6.24 |

### Example 2

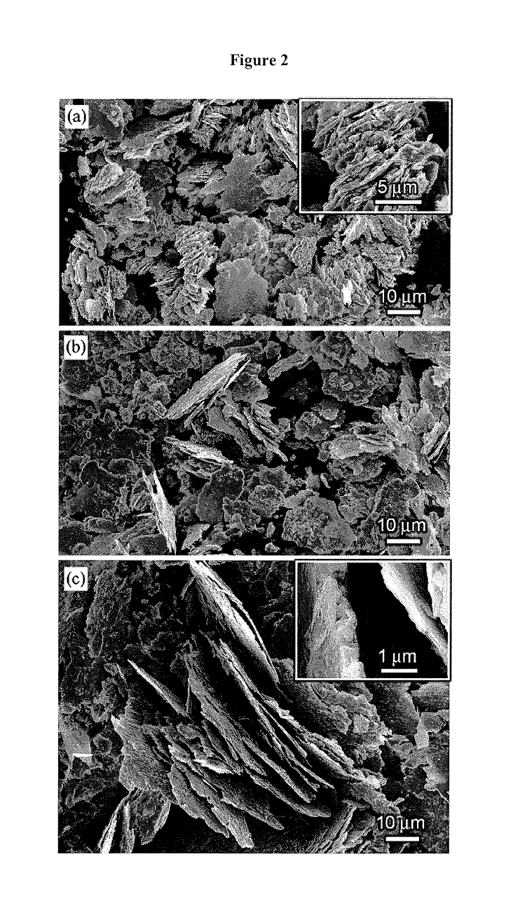

The second example describes the fabrication of SmCo₅ ultra-thin flakes via successive dry and surfactant assisted, wet, high energy ball-milling. When the dry high energy milled SmCo₅ alloy (as described in Example 1) had been subjected to a subsequent milling for 180 min. in heptane in the presence of oleic acid surfactant, the resulting powders were found to contain platelet-shaped particles, with their amount and morphology was strongly influenced by the duration of the preceding dry milling. The powder which had not been dry-milled or had been dry-milled for only 1 min. had a fairly complex morphology as shown in FIG. 2(a). Most of the powder is stacked into kebab-like agglomerates. A close-up of such an agglomerate is shown in the inset. These particles are assembled from platelet-shaped elements with an average thickness of 0.1 μm to 0.5 μm and an aspect ratio of 10 to 50. There are also a few stand-alone flakes.

When the precursor powders were dry-milled for 15 min. or longer, the solvent after the wet milling remained clear. FIG. 2(b) shows the result of wet milling after dry milling for 15 min. The powder is highly inhomogeneous with a plurality of small fragments and irregularly shaped agglomerates. However, most of the particles are shaped as platelets. The absence of nanoparticles small enough to be suspended in the solvent and the increased average aspect ratio of the particles suggests that the material is becoming more malleable. This change in the mechanical properties correlates well with the reduction of the average crystallite size (as detailed in Table 1). It has been suggested that the mechanical properties of nanocrystalline materials prepared by mechanical attrition are no longer controlled by dislocation movement through the crystals (or by lack of such movement, as with the brittle SmCo₅ compound) but by cohesion across the grain boundaries. Amorphous inter-crystalline regions, believed to be formed in the high energy ball-milling SmCo₅ material, facilitate such grain-boundary sliding.

Dry milling of the precursor for 240 min. led to a wet-milled SmCo₅ powder consisting of uniform nanoflakes of the invention with a thickness of 100 nm to 500 nm and a lateral size up to 50 μm. The typical morphology of these nanoflakes is shown in FIG. 2(c). The flakes evolved from the “dense” assembled particles similar to those shown in FIG. 1(e). The estimate of average volume of the precursor particles (300 μm³) is reasonably close to the volume of the typical nanoflake of the invention (e.g., 35 μm×35 μm×0.25 μm), indicating that little, if any, coalescence or breaking of the particles had taken place during the wet milling. Thus, the evolution of particle shape for the nominally brittle SmCo₅ alloy wet-milled after prolonged dry milling is similar to that of ductile materials. This result is consistent with the above model of nanostructure-induced ductility. It should be noted, however, that unlike some of the truly ductile materials, which reportedly may evolve into flakes while being wet-milled without added surfactants, the nanocrystalline SmCo₅ powders milled in heptane without oleic acid do not contain any flakes. Moreover, they exhibit a markedly broadened particle size distribution compared to the dry-milled precursors; this can only result from a considerable cold welding and breaking of the particle. The nanoflake powders of the invention with 7.5 wt. % oleic acid surfactant were found to have a morphology very similar to that of 15 wt. % oleic acid surfactant.

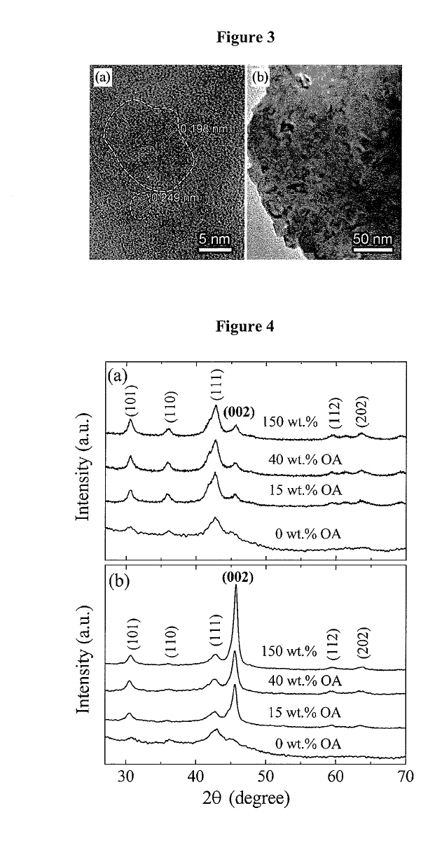

According to the x-ray diffraction peak broadening analysis, the wet milling reduces further the average crystallite size of the nanoflake powder dry-milled for 240 min., from 6 nm to approximately 5.2 nm. The lattice parameters of the SmCo₅ phase (a=0.4994 nm, c=0.4042 nm) suggest that the phase is slightly enriched with Co compared to the stoichiometric compound (a=0.5004 nm, c=0.3969 nm). Some of the SmCo₅ crystallites can be seen in the high-resolution transmission electron microscopy image presented in FIG. 3(a). The lattice spacing values of 0.198 nm and 0.249 nm correspond to the (002) and (110) planes, respectively.

The magnetic properties of SmCo₅ nanoflakes of the invention are comparable to those of their precursor powders and are associated with extremely small grain size. Table 2 presents the crystalline and magnetic properties of nanoflakes of the invention subjected to a re-crystallization annealing. The annealing increases the average crystallite size and decreases the microstrain of the SmCo₅ phase producing a new Sm₂O₃ phase. The average grain size of the SmCo₅ phase, 16.4 nm, is in agreement with the transmission electron microscopy data presented in FIG. 3(b). The changes of the average grain size and microstrain accounts for the decreased Mᵣ and increase H_{ci}. A higher intrinsic coercivity can be obtained if a lesser amount of oleic acid surfactant had been used.

TABLE 2
Structural properties of SmCo₅ phase and intrinsic coercivity H_{ci} are
set out below for milled and annealed SmCo₅ nanoflakes of the invention
(dry high energy milling for 240 min. was followed by wet milling for
180 min. with two oleic acid surfactant levels, 15 wt. % and 7.5 wt. %).
Phases were determined by x-ray diffraction.

| Annealing | | Crystallite | | | |
|---|---|---|---|---|---|
| temperature | | size^{a} | Microstrain^{a} | H_{ci}^{a} | H_{ci}^{b} |
| (° C.) | Phases | (nm) | (%) | (kOe) | (kOe) |
| no | SmCo₅ | 5.2 | 0.95 | 6.2 | 5.6 |
| 500 | SmCo₅; Sm₂O₃ | 7.9 | 0.56 | 12.3 | 14.7 |
| 650 | SmCo₅; Sm₂O₃ | 16.4 | 0.26 | 16.9 | 19.0 |

^{a}Wet milling with 15 wt. % oleic acid surfactant
^{b}Wet milling with 7.5 wt. % oleic acid surfactant

### Introduction to Examples 3 Through 10

Fabrication of anisotropic SmCo₅ nanoflakes, other nanoflakes based on intermetallic compounds with rare earth elements, such as SmCo₇, Sm₂(Co, Fe)₁₇ and Nd₂Fe₁₄B, and metal nanoflakes such as α-Fe nanoflakes produced by a single step surfactant assisted wet high energy ball milling are described in Examples 3 through 10.

Examples 3 through 10 include results related to the fabrication of:
(a) anisotropic SmCo₅ micro-particles fabricated by surfactant-assisted wet low-energy ball milling;
(b) stacked anisotropic SmCo₅ nanoflakes fabricated by surfactant assisted wet high energy ball milling;
(c) well-separated anisotropic SmCo₅ nanoflakes fabricated by surfactant-assisted wet high energy ball milling;
(d) nanoflakes based on other Sm—Co stoichiometries, such as SmCo₇ and Sm₂(Co, Fe)₁₇, fabricated by surfactant-assisted wet high energy ball-milling;
(e) nanoflakes based on Nd₂Fe₁₄B by surfactant-assisted wet high energy ball-milling; and
(f) α-Fe nanoflakes fabricated by surfactant-assisted wet high energy ball-milling

The precursor bulk materials for the rare earth based nanoflakes of the invention with hard magnetic properties were ingots, sintered permanent magnets or other powders. The precursor materials for the Fe nanoflakes were powders. The ingots were prepared by arc-melting and the permanent magnets were fabricated through the conventional powder metallurgy methods. The precursor bulk materials were crushed and grinded down to less than 300 μm. High energy ball milling of 5 to 10 g crushed powder was carried out for 15 min. to 8 h in a hardened stainless steel vial or a tungsten carbide vial, using a SPEX-8000 ball mill. Heptane (99.8%) was used as the ball milling medium and oleic acid (90%) as the surfactant. The amount of surfactant used was 7.5 wt. % to 150 wt. % of the starting powders. The harden-steel balls had diameters of 4 to 12 mm. The ball-to-powder weight ratio was 10:1 or 50:1.

Structure and morphology of the samples were examined with a Philips 3100 X-ray diffractometer, a JEOL JSM-6335F scanning electron microscope and a JEOL JEM-3010 transmission electron microscope. Magnetic properties at room temperature were measured by a vibrating sample magnetometer with the maximum field of 20 kOe. Most of the samples were magnetically saturated at 100 kOe. For x-ray diffraction and magnetic measurements, the as-milled powder samples were embedded in epoxy resin or wax and aligned in external magnetic fields smaller than the saturation field.

Examples 3 through 7 are further illustrated and detailed in FIGS. 4 through 19 of the Drawings.

### Example 3

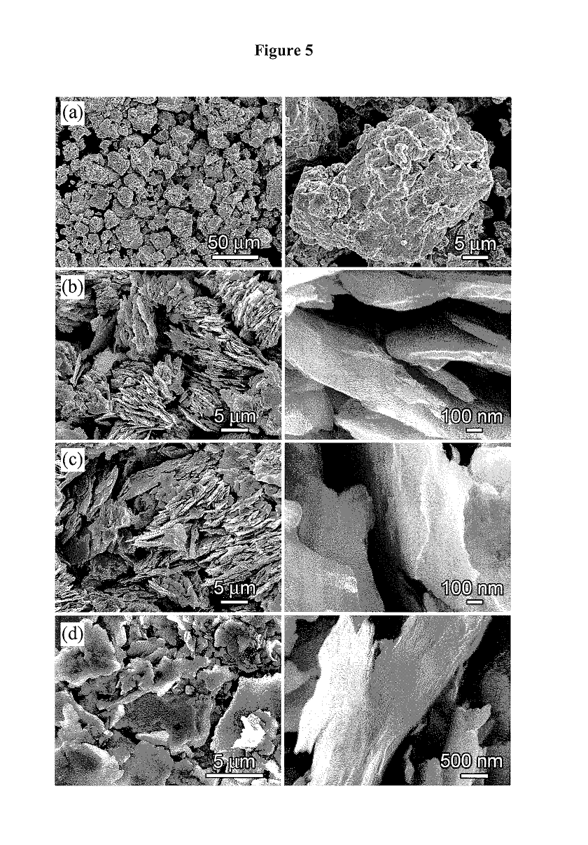

Sm₁₇Co₈₃ (at. %) alloy was prepared by arc-melting with the appropriate excess of Sm (1.5 to 4 wt. % depending on the ingot weights) to compensate for the evaporation losses. The one-step surfactant-assisted wet high energy ball milling of the Sm₁₇Co₈₃ alloy ingots with a ball-to-powder ratio of 50:1, preserved the CaCu₅-type of hexagonal crystal structure (also known as SmCo₅ phase). More interestingly, crystallographically anisotropic SmCo₅ nanoflakes with nanoscale thickness and out-of-plane (001) texture were obtained by high energy ball milling for 5 h in heptane with 15, 40 and 150 wt. % oleic acid surfactant, respectively. This result is unexpected and could not be predicted. Compared with those of the non-aligned samples, the intensities of (002) diffraction peaks of the SmCo₅ hard phase in the magnetically aligned SmCo₅ nanoflakes are much stronger (see x-ray diffraction patterns in FIGS. 4(a) & (b). The thickness of nanoflakes is in the range of 8 to 80 nm while their width is from 0.5 to 8 μm (see FIG. 5). The aspect ratio of nanoflakes is as high as 10² to 10³.

The surfactant oleic acid surfactant plays an important role in the formation of SmCo₅ nanoflakes of the invention. High energy ball milling of Sm₁₇Co₈₃ ingots in heptane without oleic acid surfactant resulted in the formation of crystallographically and magnetically isotropic SmCo₅ microparticles with more or less equiaxed shape and a size of 2 to 30 μm (see FIGS. 4 & 5). Closely packed kebab-like SmCo₅ nanoflakes of the invention were formed by high energy ball milling in heptane with 15 wt. % oleic acid surfactant. A mixture of closely packed kebab-like nanoflakes and well-separated nanoflakes was obtained in a sample prepared by high energy ball milling in heptane with 40 wt. % oleic acid surfactant. It is worth to notice that only well-separated nanoflakes (no closely packed kebab-like structure) were obtained in the sample prepared by high energy ball milling in heptane with 150 wt. % oleic acid surfactant. This indicated that a relatively large amount of oleic acid surfactant during the high energy ball milling in heptane changed the evolution of microparticles from closely packed kebab-like structures to well-separated nanoflakes. On the other hand, the different amount of surfactant (from 15 to 150 wt. %) did not change the thickness and width of the nanoflakes in this work. As mentioned previously, enhanced (001) out-of-plane texture was observed in the sample fabricated by high energy ball milling in heptane with 150 wt. % oleic acid, compared with the samples prepared by high energy ball milling in heptane with 0, 15 and 40 wt. % oleic acid, respectively (FIG. 4). The I₀₀₂/I₁₁₁ x-ray diffraction integral intensity ratio corresponding to (002) and (111) planes of the SmCo₅ hard phase are 0.5, 3.2, 3.2 and 5.5 for the samples prepared by high energy ball milling for 5 h in heptane with 0, 15, 40, and 150 wt. % oleic acid surfactant, respectively.

The effects of nanograin size- and strain-induced broadening at the full width at half maximum of the x-ray diffraction patterns can be distinguished by the Williamson-Hall plots. The results showed an average SmCo₅ grain size of 8 nm and internal strain of about 0.7% for the samples high energy ball milling for 5 h in heptane and oleic acid surfactant, as shown in FIG. 4. The in-plane transmission electron microscope examination of the SmCo₅ nanoflakes of the invention showed that the nanoflakes were composed of grains with sizes in the range of 4 to 8 nm (see FIG. 6), which was basically consistent with the x-ray diffraction results. The internal strain values of ball-milled SmCo₅ samples in this work are comparable to that of Nb phase which is in the range of 0.6-0.9% in the Cu—Nb nanocrystalline alloys prepared by high energy ball milling in argon for 12 to 35 h.

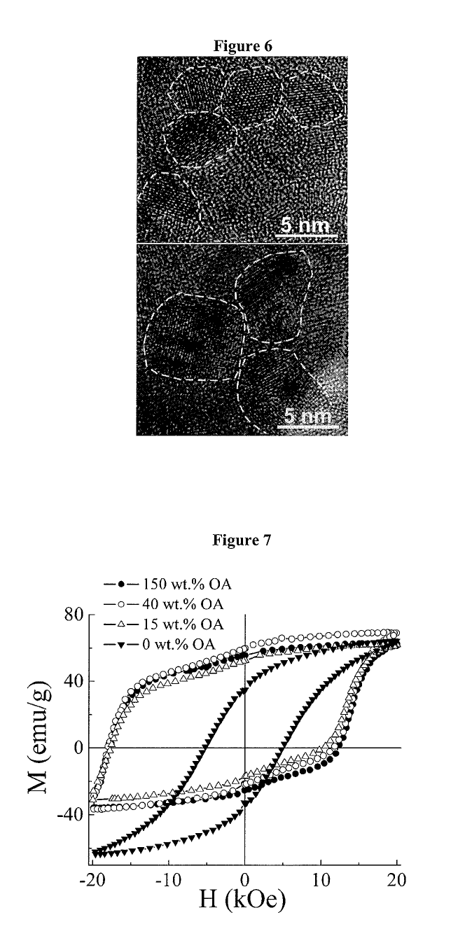

The demagnetization curves of the selected magnetically aligned SmCo₅ nanoflakes of the invention prepared by high energy ball milling for 5 h in heptane with 15, 40 and 150 wt. % oleic acid surfactant are shown in FIG. 7. All of these SmCo₅ nanoflake have the (001) out-of-plane texture. The coercivities of the SmCo₅ nanoflakes prepared with 15, 40, 150 wt. % oleic acid surfactant were 17.7, 18.0, and 18.0 kOe, respectively.

### Example 4

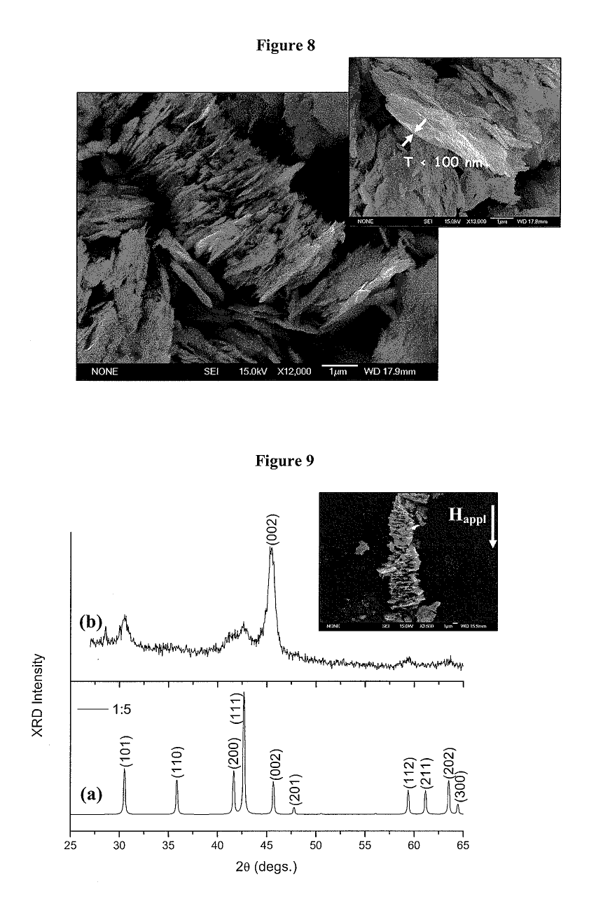

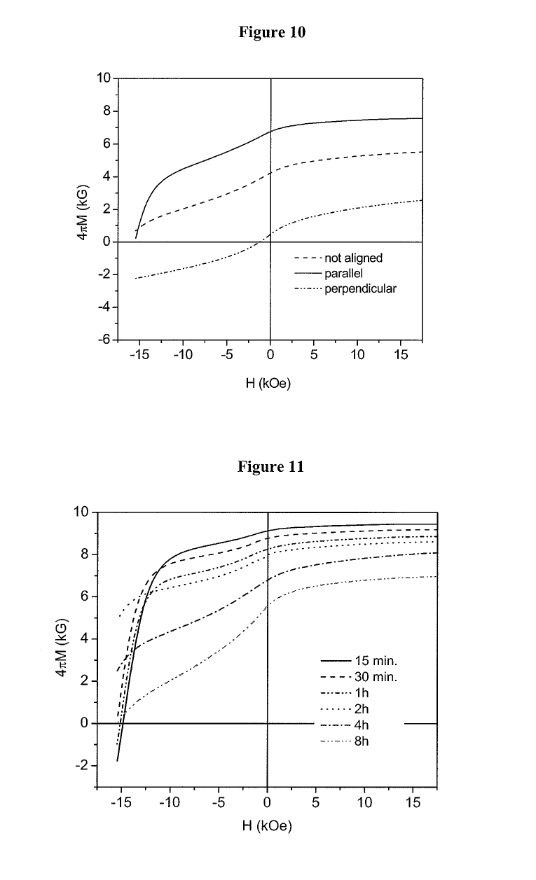

The one-step surfactant-assisted wet high energy ball milling of the Sm₁₇Co₈₃ (or SmCo₅) alloy ingots with a ball-to-powder ratio of 10:1, also preserved upon milling, the SmCo₅ (or CaCu₅-type) crystal structure. The 4 h surfactant-assisted wet high energy ball milling of the SmCo₅ alloy produces nanoflakes of the invention with a thickness below 100 nm and the other dimensions less than 5 microns (FIG. 8). These nanoflakes form also micro self-assembled stacked (“kebab-like”) structures even when no external magnetic field is applied. The nanoflakes show a texture with the easy magnetization direction c oriented perpendicular to the flake planes (along (002) direction in x-ray diffraction patterns) (FIG. 9(b) and inset). The magnetic properties of the SmCo₅ nanoflakes produced by wet high energy ball milling with 15 wt % oleic acid for 4h, are 4πMᵣ of 7 kG and H_{ci} of 15 kOe when measured parallel to the alignment direction (FIG. 10). Different demagnetization curves along different directions in respect to the alignment direction demonstrate in FIG. 10 the anisotropic character of these nanoflakes of the invention.

### Example 5

SmCo₅ precursor ingots were crushed and powders with particle size less than 106 μm were selected. These powders were further processed by high energy ball milling in heptane in the presence of 15 wt. % oleic acid surfactant. Short time milling (e.g., for 30 min.) produces a mixture of irregular particles with an incipient tendency for an increased aspect ratio. Milling for 2 h produces a considerable amount of nanoflakes of the invention with a thickness below 100 nm and the other dimensions of up to 10 μm. When aligned in an external magnetic field, the nanoflake planes are perpendicular to the direction of the applied field suggesting an out of plane texture. The nanoflake powder has a 1:5 crystallographic structure and when aligned, the easy magnetization direction c is oriented perpendicular to the nanoflake plane (along (002) direction in x-ray diffraction patterns) (similar to FIG. 9). The magnetic properties vary with the milling time as shown in FIG. 11. SmCo₅ powder milled for 15 minutes have 4πMᵣ of 9.1 kG and H_{ci} of 14.9 kOe, while for a milling time of 2 h, 4πMᵣ becomes 8 kG and H_{ci} exceeds 15 kOe. By further increasing the milling time, the remanent magnetization and squareness of the demagnetization curve, deteriorate.

### Example 6

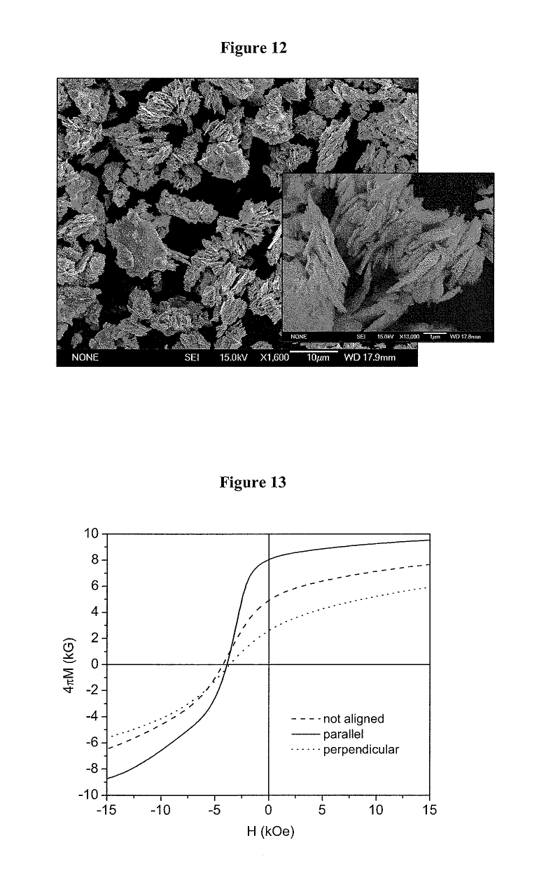

Wet high energy ball milling of SmCo₇ precursor ingots in the presence of 15 wt. % oleic acid surfactant and with a ball to powder ratio of 10:1, produces a mixture of irregular nanoflakes of the invention with submicron thickness (FIG. 12). Some nanoflakes form stacks without any externally applied magnetic field. The nanoflake powder has a complex crystallographic structure consisting of 1:7 and disordered 2:17 phases and does not show a prominent crystallographic texture. The magnetic properties derived from the demagnetization curves along the alignment direction, are 4πMᵣ of 8.5 kG and intrinsic coercivity, H_{ci} of 4.5 kOe.

### Example 7

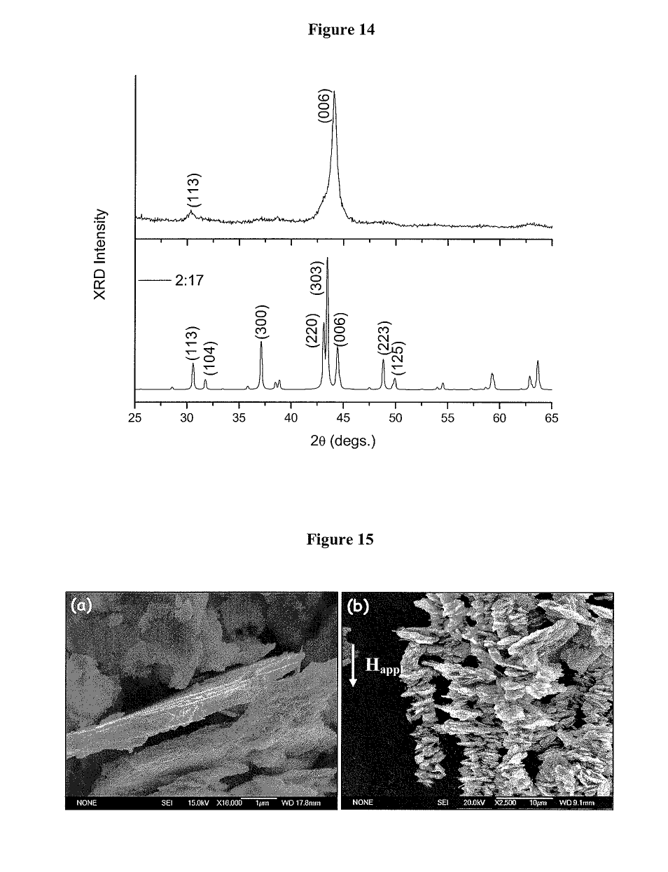

By processing Sm₂(Co_{0.8}Fe_{0.2})₁₇ precursor ingots by high energy ball milling for 4 h in the presence of 15 wt. % oleic acid surfactant and with a ball to powder ratio of 10:1, one can produce a mixture of irregular particles and nanoflakes with submicron thickness. The powder has a 2:17 rhombohedral crystallographic structure, and show texture when aligned in an externally applied magnetic field (FIG. 14). The aligned nanoflake powder has a remanent magnetization, 4πMᵣ of 9 kG and an intrinsic coercivity, H_{ci} of 2 kOe.

### Example 8

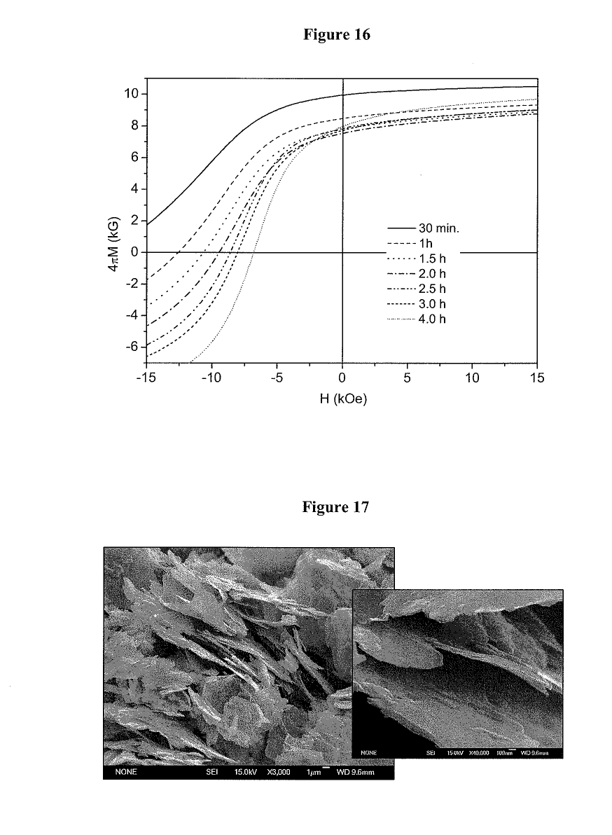

EEC-T400 magnets with a Sm(Co,Fe,Cu,Zr)_{z} (z=7-7.4) composition and the permanent magnetic properties derived from a complex cellular structure, were also subjected to high energy ball milling in the presence of various amounts of oleic acid surfactant (15 wt. % and 150 wt. %) and with a ball to powder ratio of 10:1. After 30 minutes of milling, the powder particles start to deform into platelets with an approximately micron size thickness while many other particle have irregular shapes. By increasing the milling time to 4 h, one can produce submicron nanoflakes (FIG. 15). The magnetic properties change accordingly, and the hysteresis parameters of the submicron nanoflakes of the invention milled for 4 h are 4πMᵣ of 8 kG and intrinsic coercivity, H_{ci} of 6 kOe (FIG. 16).

### Example 9

Nd—Fe—B based as-cast or homogenized (900° C. for 1 day) ingots, with or without small additions of Dy, Al and Nb, were subjected to high energy ball milling in heptane for different periods of time in the presence of 15 wt. % oleic acid surfactant and with a ball to powder ratio of 10:1. The specific stoichiometries of the investigated materials were Nd_{34.76}Fe_{63.94}B_{1.30}, Nd_{32.45}Fe_{65.65}Nb_{0.6}B₁Al_{0.3}, Nd_{33.5}Fe_{64.60}Nb_{0.6}B₁Al_{0.3} and Nd_{27.8}Dy_{5.6}Fe_{64.67}Nb_{0.6}B_{1.03}A1_{0.3}. The x-ray diffraction pattern on aligned Nd—Fe—B based powder particles after high energy ball milling for 4 h, show only a partial texture due to the nanoflakes which, most probably are polycrystalline and align along their long axis because of shape anisotropy. By increasing the milling time, the intrinsic coercivity, H_{ci}, can slightly increase at the expense of the magnetization. The maximum intrinsic coercivity does not exceed the typical values obtained in regularly milled Nd—Fe—B material, H_{ci}˜4 kOe, or it can be slightly higher with the addition of Dy (H_{ci}=5 kOe for Nd_{27.8}Dy_{5.6}Fe_{64.67}Nb_{0.6}B_{1.03}Al_{0.3}). The increase of the surfactant amount and the balls-to-powder ratio do not have a significant effect on the magnetic properties of the processed nanoflake powder particles.

### Example 10

By wet high energy ball milling in the presence of oleic acid surfactant with a ball to powder ratio of 50:1, pure Fe powders with an original particle size of 40 μm transformed into nanoflakes of the invention with a thickness less than 100 nm. Smaller thickness can be obtained with longer milling. FIG. 17 shows typical Fe nanoflakes of the invention obtained by milling Fe powder for 16 h in heptane and 15 wt. % oleic acid surfactant.

To further describe the nanoflakes of the invention, a mechanism for formation of crystallographic isotropic nanoflakes from brittle magnetic materials is suggested.

Formation of crystallographically isotropic nanoflakes from brittle magnetic materials requires prior conversion of the material into a malleable nanocrystalline state such as by dry high energy ball milling. Size of the particles at this stage is not critical for the subsequent shape evolution, but it will influence the lateral dimension of the final flakes. The typical size of the SmCo₅ particles subjected to dry high energy ball milling for several hours is 10 to 20 μm. This represents the dynamic equilibrium between constantly occurring breaking and merging (cold welding) of the particles. The nanostructure emerges inside the particles subjected to high energy ball milling via introduction of one-dimensional lattice defects (dislocation), arrangement of the dislocations into two-dimensional lattice defects (low-angle boundaries) and gradual increasing of misorientation angle of these boundaries as they accommodate new dislocations. When the average misorientation angle becomes greater than 10 to 15 degrees, the original low-angle boundaries (subgrain boundaries) become high-angle boundaries (grain boundaries). The grain-boundary atoms are, in general, less ordered and have, also in general, the lower coordination number than the atoms of the bulk material. The very high specific area of the grain boundaries, similar to the specific grain-boundaries area characteristic of the SmCo₅ material with the average grain size around 5-6 nm, enables deformation of the material via grain-boundary sliding. For inherently brittle materials similar to SmCo₅ this additional deformation mode results in a dramatic increase of their overall plasticity. After the originally brittle material is converted into the malleable nanocrystalline particles ranging from few microns to few tens of microns in size, it is subjected to the second wet, surfactant-assisted high energy ball milling. During this second high energy ball milling, the malleable nanocrystalline particles undergo repeated microforging and evolve into ultrathin flakes. The surfactant(s) surrounding the particles function to keep them at the distance, thus preventing two or more particles from being simultaneously forged and cold welded to each other.

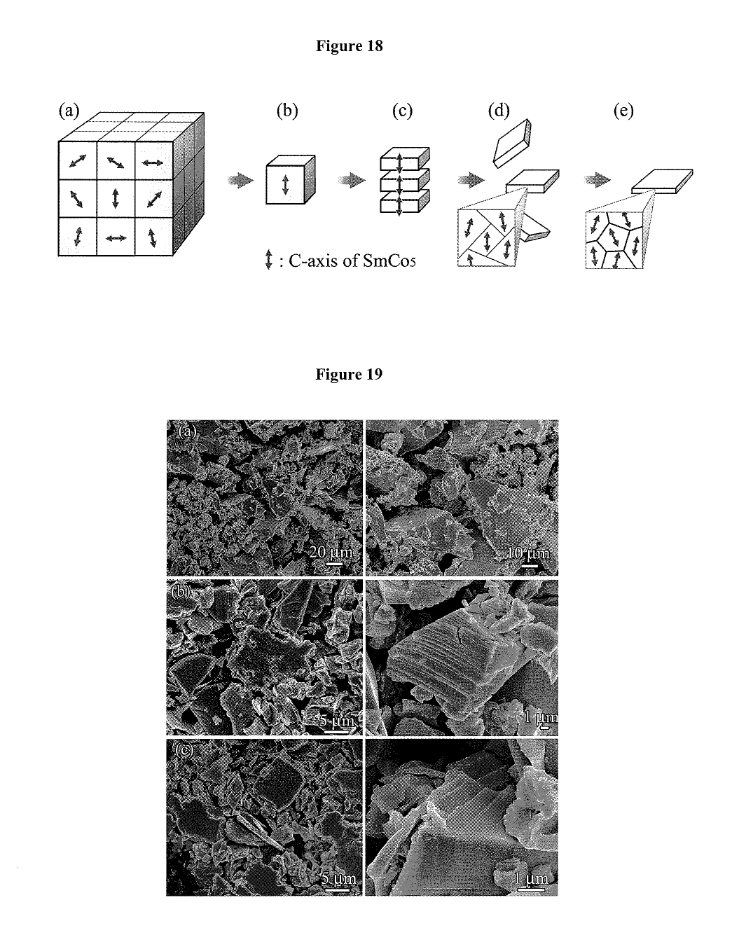

The following is a proposed mechanism for formation of crystallographically anisotropic nanoflakes from brittle magnetic materials. The formation of SmCo₅ single-crystal flakes and anisotropic polycrystalline nanoflakes during the surfactant-assisted high energy ball milling considers the following steps as shown in the schematic FIG. 18:

(1) the fragmentation of the bulk SmCo₅ ingot with poly-microcrystalline grains of tens of microns in size into micron-sized single-crystal irregular particles by crushing;

(2) the basal cleavage on the easy glide (001) basal planes of single-crystal irregular SmCo₅ microparticles to form single-crystal micron flakes without an appreciable increase in the density of crystal defects. The cleft and stepped (001) basal planes of SmCo₅ can be commonly seen (FIG. 19) in the single-crystal micron flakes prepared by high energy ball milling from 0.25 to 0.5 h;

(3) cleavage on the (001) planes continues via layer-by-layer peeling or plane splitting to obtain single-crystal submicron flakes with smaller crystalline sizes and flake lengths, accompanied by increasing dislocation density;

(4) the development of small-angle subgrain boundaries in the submicron flakes as a mechanism of accommodating localized deformation and dislocations (as described in L. Guo, Z. H. Wu, T. Liu, S. H. Yang, Physica E 8, 199, 2000), as long as the new boundaries remain small-angle-type, orientation of the subgrains does not deviate much from the orientation of the single-crystal precursor flakes;

(5) with the continued ball-milling, thicknesses of the flakes become smaller (to form, eventually, the flakes with nanoscaled thicknesses, as described in L. S. Vasil'ev and S. F. Lomayeva, J. Mater. Sci. 39, 5411, 2004) Consequently, the resulting polycrystalline nanoflakes have a relatively well-preserved crystal order and a strong (001)-out-of-plane texture inherited from its single-crystal precursors;

(6) the grain sizes, lengths of the nanoflakes become smaller with increasing the ball-milling time (up to 8 h in this work).

Finally, textured poly-nanocrystalline SmCo₅ nanoflakes are formed. Whereas, it should be mentioned that, the continuous thickness decrease of the poly-nanocrystalline nanoflakes during the high energy ball milling is proposed mainly to be due to the significant ductility exhibited by brittle materials in a nanocrystalline state (as described in A. M. Gabay, N. G. Akdogan, M. Marinescu, J. F. Liu, and G. C. Hadjipanayis, J. Phys. Condens. Mater., in press, 2010) rather than the basal cleavage of the easy glide (001) planes which dominated in the stage of formation of single-crystal micron and submicron flakes. The cited references are incorporated herein by reference.

Other grinding or milling processes, such as wet grinding using a NETZSCH MiniCer Small Media Mill, can produce anisotropic SmCo₅ nanoflakes in liquid media, such as heptane, isopropyl alcohol or other solvents, without the addition of any surfactants.

### Example 11

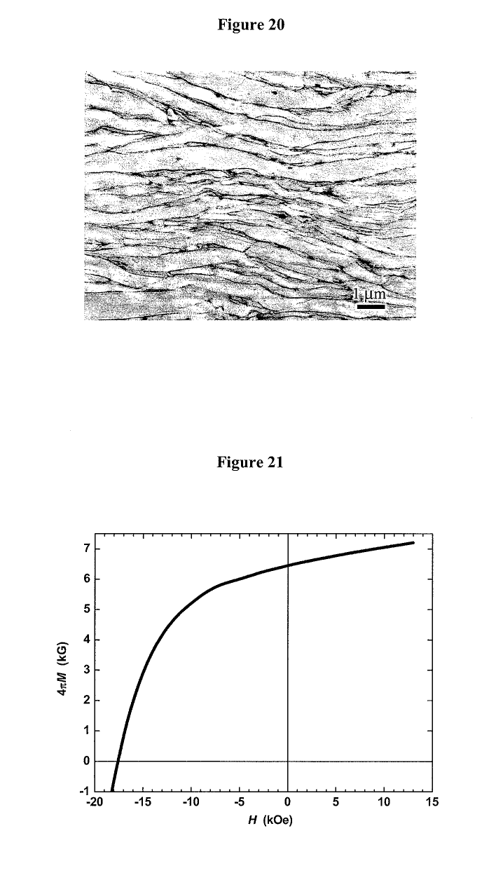

Isotropic SmCo₅ nanoflakes prepared by surfactant-assisted HEBM in heptane with 15 wt. % oleic acid surfactant, with initial dry HEBM, and anisotropic SmCo₅ nanoflakes without initial dry HEBM, were hot-pressed at 650° C. for 5 min. with a pressure of 3 ton/cm². The hot-pressed samples typically consist of SmCo₅ phase, and sometimes Sm₂Co₁₇ and Sm₂O₃ as impurity phases. The typical morphology of the hot pressed specimens from isotropic SmCo₅ nanoflake precursors, reveling the constituent consolidated nanoflakes is shown in FIG. 20. The nanoflakes arrange in layers, parallel to the hot pressing direction. The demagnetization curve of a specimen fabricated by hot pressing isotropic SmCo₅ nanoflake precursors is shown in FIG. 21. This particular specimen was subjected to HEBM for 4 h, followed by wet HEBM in heptane with 15 wt % OA (of the powder weight) for 3 h and the resulting nanoflakes were subjected to a pre-consolidation processing involving vigorous tapping. The density of the hot pressed specimen was 7.9 g/cc. The magnetic parameters are remanent magnetization, Mᵣ=6.4 kG, intrinsic coercivity, H_{ci}=17.6 kOe and maximum energy product, (BH)ₘₐₓ=9.7 MGOe. The magnetic properties of the bulk composite magnets of the invention can be improved by optimizing the hot pressing parameters.

What is claimed is:

1. Permanent magnets fabricated from magnetic nanoflakes produced by surfactant-assisted, wet, high energy ball-milling, wherein the nanoflakes are anisotropic.

2. Permanent magnets fabricated from magnetic nanoflakes produced by surfactant-assisted, wet, high energy ball-milling, wherein the nanoflakes are isotropic.

3. Permanent magnets fabricated from magnetic nanoflakes produced by surfactant-assisted, wet, high energy ball-milling preceded by dry high energy ball milling; wherein the nanoflakes are isotropic.

4. Permanent magnets according to claim 1, 2 or 3, wherein the surfactant is selected from the group consisting of anionic, cationic, nonionic, amphoteric, zwitteronic surfactants and mixtures thereof

5. Permanent magnets according to claim 1, 2 or 3, wherein the surfactant is oleic acid.

6. Permanent magnets according to claim 1, 2 or 3, wherein the nanoflakes are polycrystalline.

7. Permanent magnets according to claim 1, 2 or 3, wherein the nanoflakes comprise RE-TM permanent magnet alloys, where RE represents one or more rare earth elements and TM represents one or more transition metals.

8. Permanent magnets according to claim 1, wherein the nanoflakes arrange themselves into kebab-like stacks along nanoflakes shortest axes.

9. Permanent magnets of claim 8, where the nanoflakes are SmCo₅ nanoflakes.

10. Permanent magnets according to claim 1, wherein the nanoflake precursors are well separated anisotropic SmCo₅ nanoflakes.

11. Permanent magnets according to claim 2 or 3, wherein the nanoflake precursors are well separated isotropic nanoflakes.

12. Soft magnets fabricated from Fe-based nanoflakes produced by surfactant-assisted, wet, high energy balling-milling.

13. RECoₓ permanent magnets fabricated from nanoflakes produced by surfactant-assisted, wet, high energy ball-milling, wherein x is 3 to 6 and RE represents rare earth elements selected from the group consisting of Sm, Gd, Er, Tb, Pr, and Dy and mixtures thereof.

14. The RECoₓ permanent magnets of claim 13, further comprising no more than about 10 atomic % of other metallic or non-metallic elements.

15. RE(CoᵤFeᵥCu_{w}Zrₕ)_{z}, permanent magnets fabricated from nanoflakes produced by surfactant-assisted, wet, high energy ball-milling, wherein u is 0.5 to 1, v is 0 to 0.45, w is 0 to 0.3, h is 0 to 0.07, and z is 6 to 9; and wherein RE is selected from the group consisting of Sm, Gd, Er, Tb, Pr, Dy and combinations thereof.

16. RE_{11.7+x}TM_{88.3-x-y}B_{y} permanent magnets fabricated from nanoflakes produced by surfactant-assisted, wet, high energy ball-milling, wherein x is 0 to 5, y is 5 to 7 and RE is selected from the group consisting of rare earth elements Nd, Pr, Dy, Tb, and combinations thereof, and TM is selected from the group consisting of the transition metal elements Fe, Co, Cu, Ga, Al and combinations thereof.

17. Permanent magnets according to claims 13 to 16, wherein the nanoflakes form a laminated structure.

18. Permanent magnets according to any of claims 13 to 16, wherein the nanoflakes are bonded with a binder.

19. The permanent magnets of claim 18, wherein the binder is selected from the group consisting of metallic binders or non-metallic binders.

20. The permanent magnets of claim 18, wherein the binder comprises an epoxy binder.

21. A method of manufacturing permanent magnets comprising the steps of:
(a) forming nanoflakes by surfactant assisted wet, high energy ball-milling; and
(b) fabricating permanent magnets from the nanoflakes.

22. The method of claim 21, wherein the step of forming the nanoflakes further comprises the use of dry high energy ball-milling prior to the surfactant assisted wet, high energy ball-milling.

23. The method of claim 21, wherein the step of fabricating the permanent magnets is selected from the group consisting of sintering, plasma sintering, infrared sintering, microwave sintering, hot pressing, die upsetting, combustion driven compaction, compression molding, injection molding, calendaring, and combinations thereof.

24. Permanent magnets comprising isotropic or anisotropic, polycrystalline, nanoflake permanent magnet powders fabricated by surfactant-assisted, wet, high energy ball-milling of precursor materials selected from the group consisting of:
(a) SmCo₅ nanoflakes as illustrated in FIG. 2;
(b) SmCo₅ nanoflakes as illustrated in FIG. 3;
(c) SmCo₅ microparticles and nanoflakes as illustrated in FIG. 4:
(d) SmCo₅ microparticles and nanoflakes as illustrated in FIG. 5;
(e) SmCo₅ nanoflakes as illustrated in FIG. 6;
(e) SmCo₅ microparticles and nanoflakes as illustrated in FIG. 7;
(f) SmCo₅ nanoflakes as illustrated in FIG. 8;
(g) SmCo₅ nanoflakes as illustrated in FIG. 9;
(h) SmCo₅ nanoflakes as illustrated in FIG. 10;
(i) SmCo₅ nanoflakes as illustrated in FIG. 11;
(j) SmCo₇ nanoflakes as illustrated in FIG. 12;
(k) SmCo₇ nanoflakes as illustrated in FIG. 13;
(l) Sm₂(Co_{0.8}Fe_{0.2})₁₇ nanoflakes as illustrated in FIG. 14;
(m) Sm(Co,Fe,Cu,Zr)_{z} (where z=7 to 7.4) nanoflakes as illustrated in FIG. 15;
(n) Sm(Co,Fe,Cu,Zr)_{z} (where z=7 to 7.4) nanoflakes as illustrated in FIG. 16;
(n) α-Fe nanoflakes as illustrated in FIG. 17;
(o) single-crystal micron, submicron nanoflakes and textured polycrystalline nanoflakes of SmCo₅ as illustrated in FIG. 18; and
(p) SmCo₅ nanoflakes as illustrated in FIG. 19.
